(19) United States
(12) Patent Application Publication
(10) Pub. No.: US 2004/0013868 A1
(43) Pub. Date: Jan. 22, 2004

(54) Low emissivity article with low-e-fluoropolymer layer

(76) Inventors: Michael Dadalas, Eggenfelden (DE); Friedrich Kloos, Mainz (DE); Christian Gaag, Emmerting (DE); Hermann Reiter, Pleiskirchen (DE)

Correspondence Address: 3M INNOVATIVE PROPERTIES COMPANY, PO BOX 33427, ST. PAUL, MN, 55133-3427, US

(21) Appl. No.: 10/333,440

(22) PCT Filed: Aug. 8, 2001
(86) PCT No.: PCT/US01/24862

(30) Foreign Application Priority Data
Aug. 29, 2000 (DE) 10042464.3

(51) Int. Cl. B32B 5/16

(52) U.S. Cl. 428/327; 427/402; 428/323

(57) ABSTRACT

The invention provides a layer of fluoropolymer having dispersed therein infrared absorbing particles as a low emissivity layer to reduce the amount of cooling or heating required to maintain a desired temperature for an interior space. The invention also provides a low emittance article comprising a substrate having on at least one major surface thereof at least two layers, the outermost layer of which comprises a fluoropolymer and IR-absorbing particles in the form of flakes distributed in the outermost layer. The invention further provides a composition for producing a low emissivity coating, the composition comprising a dispersion of a fluoropolymer and IR-absorbing particles in the form of flakes.

### FIELD

The present invention relates to technical membranes that comprise a low emissivity layer (low-e layer) comprising a fluoropolymer having dispersed therein infrared absorbing particles. The present invention further relates to a roof, wall or tent that comprises a low-e layer.

### BACKGROUND

In the construction of buildings, the use of membranes is becoming more and more popular. Such membranes, also called technical membranes, typically comprise a glass fiber or polyester fiber web, e.g. glass fiber textile, that is coated with polyvinyl chloride, polytetrafluoroethylene or silicone resin. Such membranes can be used for example as roofs to cover large areas such as in football stadiums and airport halls. The membranes are especially suitable for this purpose due to their low weight making it possible to make lightweight roof constructions. For example, the Puchheim city hall, with its multilayer roof skin was made primarily of noncombustible lightweight membrane materials and was honored with the third awarding of the international prize for textile architecture at TechTextil 1999. Thermal insulation was implemented by means of sand integrated between several layers. Similarly the Munich Airport Center (MAC) West with its forum roof made of a combination of a glass fiber membrane coated with polytetrafluoroethylene (PTFE), and a multilayer safety glass was awarded a prize.

Typically, these membranes also have the property of repelling dirt and they have a high resistance to rotting. Preferably, these membranes are light transmitting, i.e. translucent and are fire proof. Noncombustible materials have been disclosed in DE A 23 15 259, which describes a textile that is coated with a glass bead tetrafluoroethylene polymer mixture and which is not combustible. However, this textile does not have a climatizing effect. According to DE A 197 40 163, an adhesive layer preferably made of silicone rubber, latex milk, or a phthalate resin adhesive is applied to a glass fiber fabric, whereupon glass beads are pressed into the adhesive layer. This material is intended to provide high mechanical tensile and tear strength, high light reflection, satisfactory thermal insulation and light transmission, a high degree of resistance to fire, resistance to wear, weathering, contamination and insect pests, and an extremely pleasing aesthetic effect. However, there is an interest in improving these properties, particularly the thermal insulation and fire resistance.

Particularly in areas that experience a hot climate, it is desirable that technical membranes can reduce the heat transport between the outside and an interior space. Heat can be transported by several ways between a warm and a cool place. Such ways include convection, heat conduction as well as transport of heat through radiation.

Heat transport through radiation involves a body at a higher temperature radiating electromagnetic radiation against a body at a lower temperature. The intensity of this radiation depends on the temperature difference between the two bodies. The emitted power or emittance is given by the following formula:

W=εσT⁴

wherein W represents the emittance, ε represents the emissivity and σ is the Stephan-Boltzman constant. The emissivity is a value between 0 and 1 and is the ratio of the radiation emitted by a surface to the radiation emitted by a perfect black body at the same temperature.

This type of heat transport can amount to 90% of the total heat transport. Particularly the radiation in the infrared part of the spectrum will contribute to heating and is moreover experienced as unpleasant by human beings. For example, at the same ambient temperature, a reduced level of infrared radiation will provide more comfort. Further, it has been found through studies that without sacrificing the comfort level, a higher ambient temperature can be tolerated if the level of infrared radiation is reduced or minimized. Accordingly, by reducing the infrared emission, one can allow a higher temperature for a room, thereby saving costs in cooling the room.

EP 1 053 867 discloses a technical membrane that comprises a glass fiber web that has been coated with a modified PTFE on which there is provided a so-called low-e coating. Although EP 1053867 does not give much detail as to the composition of this low-e coating, it appears that this low-e coating is applied through vacuum deposition. This has the disadvantage however that the low-e coating is prone to being damaged when constructing for example a roof therewith or while cleaning and moreover is prone to corrosion. Accordingly, it is taught to use a protective coating on the low-e coating. Unfortunately, this reduces the effectiveness of the low-e coating.

WO 99/39060 similarly teaches a technical membrane that comprises a low-e coating. No details are given as to the composition of this low-e coating. WO 99/39060 teaches to arrange the technical membrane on a sound barrier layer so as to additionally provide for sound insulation. WO 99/39060 also teaches the desire to protect the low-e coating with a protective layer against abrasion during cleaning.

Metallized coatings for textiles have also been used in for example EP 927 328 as electromagnetic camouflage materials.

On the other hand, the use of fluoropolymer coatings containing metal particles on textiles has been practiced in the art for various reasons. For example JP 05-318659 teaches coating a glass fiber textile with a fluoropolymer coating that contains aluminum particles in order to provide for liquid and gas barrier properties and additionally reflection of heat or light. U.S. Pat. No. 3,709,721 teaches polytetrafluoroethylene (PTFE) coatings that comprise a hard particulate filler such as for example aluminum to provide a heat and abrasion resistant material. WO 96/05360 teaches a multi-layer textile composite that has layer of fluoropolymer having aluminum particles arranged as an inner layer. The textile composite is taught for use in conveyor belts that are used at elevated temperature in for example commercial food cooking processes. However, none of these teachings have appreciated the low emissivity properties that may be obtained with a fluoropolymer layer containing metal particles.

### SUMMARY OF THE INVENTION.

The present inventors have thus determined it desirable to find an improved low-e layer that can be used in a technical membrane to effectively reduce emission of electromagnetic radiation, in particular of infrared radiation. It would furthermore be desirable that such low-e coating has a good abrasion resistance and does not require the use of a protective layer. It would be furthermore desirable to find low emittance materials that are difficult to burn, i.e. materials that can be classified according to DIN 4102 as hardly flammable or non-flammable material. According to one of the requirements in order to be classified according to DIN 4102 as nonflammable or hardly flammable material, the material should have a caloric value of less than 4200 J/g as measured according to DIN 51900.

In accordance with the present invention, it was found that a layer of fluoropolymer having dispersed therein infrared absorbing (IR-absorbing) particles can be used as a low-e layer, i.e. such a layer has a low emissivity (0.6 or less, preferably 0.5 or less, more preferably 0.4 or less) and can be used to reduce the amount of heating or cooling that is required to maintain an interior space at a desired temperature. By interior space is meant a space enclosed by a roof and/or walls such as for example a room or hall in a building. The low-e layer can be used as a barrier layer for infrared radiation and can be used to reduce the amount of infrared radiation in a room.

In a particular aspect of the present invention, the low-e layer is arranged as the outermost layer of a low emittance article, e.g. a technical membrane, so as to achieve an emissivity of not more than 0.6 for the low emittance article.

In a still further aspect, the present invention provides a low emittance article comprising a substrate having on at least one-major surface thereof at least two layers, the outermost layer of which comprises a fluoropolymer and IR-absorbing particles in the form of flakes distributed in the outermost layer. The IR-absorbing particles typically have an average particle size of less than 25 μm, typically less than 15 μm, preferably less than 3 μm, more preferably not more than 0.8 μm. The IR-absorbing particles are preferably distributed in the outermost layer in an amount of at least 10%, more preferably at least 16% by weight. The term “average particle size”, in case the particles have a substantially non-spherical shape, indicates the average along the largest dimension of the particles.

In another aspect, the present invention provides a coating composition for producing a low emissivity coating, the composition comprising a dispersion of a fluoropolymer and metal particles in the form of flakes.

The invention in one of its aspects also provides a roof, wall or tent that comprises a low emissivity layer of a fluoropolymer having dispersed therein infrared absorbing particles.

### DETAILED DESCRIPTION OF THE PRESENT INVENTION

The present invention has recognized that a coating of fluoropolymer having dispersed therein IR absorbing particles, can effectively be used as a low emissivity coating, i.e., a layer that provides a barrier against heat transport through radiation, in particular infrared radiation. The low-e coating has a high scratch and abrasion resistance. Further, articles including the low-e coating such as technical membranes are easy to transport and handle and can be manufactured in a convenient and cost effective way. The low-e coating in accordance with this invention typically has an emissivity of not more than 0.6, preferably more than 0.5, more preferably not more than 0.4. The low-e coating typically emits IR radiation only slowly. Accordingly, when arranged towards the innerspace of a room, the low-e coating will emit less IR radiation to the room and thereby help cooling the room. Additionally, during the night when the room may cool too much, the low emissivity of the low-e coating will help protect the room against cooling.

The low-e coating contains a fluoropolymer. Suitable fluoropolymers for use in the low-e coating are typically fluoropolymers that have a fluorinated carbon backbone. Preferably the fluoropolymer backbone is at least 50% by weight fluorinated. The partially fluorinated backbone of the fluoropolymer may in addition to fluorine contain hydrogen or chlorine. The fluoropolymer for use in the low-e coating may also include perfluoropolymers, i.e., polymers that have a fully fluorinated or perfluorinated backbone. Examples of fluoropolymers that can be used in the low-e coating include polytetrafluoroethylene (PTFE) and polymers comprising one or more units derived from vinylidene fluoride, chlorotrifluoroethylene, ethylene, propylene, hexafluoropropylene, fluorinated vinyl ethers including perfluoro vinyl ethers such as perfluoromethyl vinyl ether, perfluoro(methoxyethyl vinyl) ether, perfluoro (propyl vinyl) ether, perfluoro (2-(n-propoxy)propyl vinyl) ether and perfluoro(ethoxyethyl vinyl) ether. Fluoropolymers for use in the low-e coating further include for example in addition to PTFE, PTFE modified with for example hexafluoropropylene or a perfluorovinyl ether and thermoplastic melt-processable fluoropolymers such as copolymers of tetrafluoroethylene and hexafluoropropylene and/or one or more perfluorovinyl ethers. It will further be clear to one skilled in the art that mixtures of fluoropolymers may be used as well such as for example mixtures of PTFE and thermoplastic melt-processable fluoropolymers.

The infrared absorbing particles for use in the low-e coating are preferably metal particles including particles that have been provided with a metal coating on their surface such as for example glass microspheres having been metallized at their surface. The metal particles may be oxidized at their surface. Metal particles are capable of absorbing IR radiation and have a low emissivity.

Examples of suitable metal particles include noble metals such as silver or gold as well as other metals such as aluminum, copper, zinc and combinations thereof, including alloys of such metals. The average particle size of the IR absorbing particles is typically less than 25 μm, preferably less than 3 μm, more preferably in the order of colloidal particles, i.e., not more than 800 nm. By using smaller particles, the light transmission of the coating can be optimized while maintaining a low emissivity. The geometry of the particles can be spherical or substantially spherical such as elliptical. However, in a preferred embodiment, the particles are in the form of flakes preferably having an average particle size, measured along the largest dimension, of not more than 25 μm, preferably not more than 20 μm, and preferably having an average thickness of between 0.01 μm and 1 μm, preferably between 0.05 μm and 0.5 μm. IR-absorbing particles in the form of flakes may provide the advantage that they are capable of orientation during coating such that even at low amounts of the particles, an effective low emissivity can be obtained.

The amount of the IR-absorbing particles is typically at least about 2% by weight based on the total weight of solids, preferably at least 5-6% by weight, more preferably at least 10% by weight and most preferably at least about 15-16% by weight. A typical range of the amount of IR-absorbing particles is between 2% by weight and 70% by weight, preferably between 10 and 50% by weight.

The thickness of the low-e layer is preferably kept minimal to provide for a higher light transmission. Typically, the thickness of the low-e layer will be not more than 0.3 mm, preferably not more than 0.05 mm.

The low-e coating may contain additional ingredients such as non-flammable fillers such as glass spheres, mica pigments, ceramics or titanium dioxide. Such fillers may for example be included in the low-e coating in an amount of 2 to 80% by weight.

The low-e coating can be used to provide a low emittance material, in particular to provide a technical membrane, e.g., a light translucent membrane. The low emittance material comprising the low-e coating will typically have a emissivity of not more than 0.6, preferably not more than 0.5 and more preferably not more than 0.4. The desired emissivity can be selected by one skilled in the art through routine experimentation and will generally depend on such factors as the thickness of the low-e coating, the position of the low-e coating in the layer package of the low emittance material, the amount of IR absorbing particles in the low-e coating and the size and geometry of the IR absorbing particles. In a low emittance material, the low-e coating is preferably provided as close as possible to the surface of the low emittance material, most preferably as an outermost layer. Light transmission of the material can be increased by bleaching processes such as annealing and UV radiation. The low emittance material will preferably have a light transmission of at least 0.5%, preferably at least 0.8%, more preferably at least 1%. With the low emittance material of the present invention, even a light transmission of 2% or more, e.g., 9% or more can be achieved. It should be noted here that a light transmission of at least 2% may already provide a sufficient amount of supporting light in a room.

In a particular embodiment, the low emittance material comprises a substrate, for example a flat substrate provided with the low-e coating. Preferably, the substrate has a high temperature resistance to allow for the use of high temperatures to provide coatings to the substrate. Examples of suitable substrates include glass fiber webs or fabrics, e.g. glass fiber cloth which are UV-resistant, organic materials such as polyparaphenylene terephthalamide which is commercially available under the brand KEVLAR, metal fiber fabrics, mineral fiber materials such as felts and mats of glass wool and rock wool. The fabric substrates may be woven or nonwoven. Preferably, the low emittance material comprises at least two layers on the substrate, the outermost layer of which is the low-e coating. The one or more further layers of a multi-layer low emittance material may comprises further layers of fluoropolymer, in particular of polytetrafluoroethylene. Such further layers will generally not comprise the IR absorbing particles of the low-e coating. Such one or more further layers may for example be provided to increase the adhesion of the low-e coating to the substrate of the low emittance material.

The one or more further layers may contain additional ingredients such as non-flammable fillers such as glass spheres, mica pigments, ceramics or titanium dioxide. Such fillers may for example be included in a further layer in an amount of 2 to 80% by weight.

Such a low emittance material may be provided as a translucent technical membrane with the low-e coating as an outermost layer arranged towards the interior of a room. Because of the low emissivity level and adsorption of infrared radiation, the interior will be cooled and moreover, because of the reduced infrared radiation in the room, the climate therein will feel more comfortable. Further, at times when the exterior temperature drops, infrared emission from the low emittance material contributes to protecting the room against cooling. Accordingly, the low emittance material may act as a heat accumulator that may be charged by solar radiation during the day and which slowly releases the accumulated energy during the night. Accordingly, the low emittance materials are particularly suitable for use in areas that have a hot climate such as tropical and desert climates.

The low emittance material may be obtained by coating a substrate, for example glass fiber fabric, with a coating composition comprising the fluoropolymer and the IR-absorbing particles. Typically, an aqueous dispersion of the fluoropolymer and IR-absorbing particles will be used as the coating composition. The coating composition may contain multimodal particle distributions of the fluoropolymer as taught in DE 197 26 802 to provide for dense coatings and a smooth surface. A preferred coating composition may contain the IR absorbing particles, for example metal particles such as aluminum in an amount of at least 10% by weight. The low-e coating composition may be applied for example through dip coating. Further, prior to coating the low-e coating, the substrate may first be coated with one or more fluoropolymer layers, e.g., polytetrafluoroethylene, which do not contain IR absorbing particles. Suitable glass fiber coating methods are disclosed in for example DE 23 15 259 and U.S. Pat. No. 2 731 068, which are modified such that preferably the last coating is a coating composition used to provide the low-e layer.

The low emittance material typically will have a caloric value according to DIN 51 900) of not more than 6000 J/g, preferably less than 4200 J/g. Accordingly, the low emittance material will be hardly flammable.

The low-e coating may be used in roofs, wall or tents. Such roofs, wall or tents have been disclosed in EP 1 053 867 and WO 99/39060. Typically, such roofs, wall or tents comprise a translucent technical membrane comprising a substrate, for example as disclosed above that is provided on at least one side with a fluoropolymer coating, e.g., polytetrafluoroethylene, and a low-e coating, preferably as an outermost layer. The low-e coating is typically arranged towards the inner side of a room thereby reducing the amount of energy needed to cool the room. When the low-e coating is arranged towards the exterior, the low-e coating wilt inhibit loss of heat through emission towards the outside and thus reduces the amount of heating that is required. By providing the low-e coating on both sides, an improved heat insulation results.

A translucent technical membrane having the low-e coating may further be combined with other layers such as for example sound barrier layers as disclosed in for example WO 99/39060 which is incorporated herein by reference. As disclosed in this publication, a light transmitting sound barrier layer is arranged at a distance to the outer layer of the technical membrane that contains a low-e coating. As is further disclosed in this publication, the substrate of the technical membrane, e.g., glass fiber fabric, preferably has openings in it such that sound and light can pass through the technical membrane to the light transmitting sound barrier.

Apart from using the low-e coating in a roof, wall or tent, the low-e coating may also be used in other materials that are typically used to cover a room against penetration of sun rays. Such materials include in particular shading materials including movable shading materials such as blinds, awnings, roll-down shutters, curtains, jealousies and lamella. Such shading materials may be used on their own to mitigate temperature conditioning of a room or they can be used in combination with a roof or wall having the low-e coating.

### EXAMPLES

The following examples serve to illustrate the invention further without however the intention to limit the invention thereto.

Test Methods:

The emissivity of the materials in the following examples was measured using an Emissionmeter Model AE from Devices and Services Co., Dallas, Tex., USA according to the procedures laid out by the manufacturer of the machine. The emissionmeter was equipped with a differential thermopile as a radiation detector. The radiation detector was heated to 82° C. and has a nearly constant response to the thermal wavelengths (3 to 30 μm). The device was first calibrated using a standard having high emissivity (0.93) and a standard having a low emissivity (0.04).

The unknown sample was thereafter measured against the standard having a high emissivity.

Abbreviations:

PTFE: polytetrafluoroethylene.

FEP: copolymer of tetrafluoroethylene and hexafluoropropylene commercially available as Dyneon™ FEP X 6300.

PFA: copolymer of tetrafluoroethylene and perfluoro-(n-propyl vinyl) ether commercially available as Dyneon™ PFA 6900 N.

### Comparative Example

A glass cloth in linen weave having a weight per unit area of 442 g/m² was coated on both sides with 659 g/m² of coating material in four coats. The first coating was applied using a 50% by weight dispersion of PTFE (diluted from commercially available PTFE dispersion Dyneon™ TFX 5060), the second and third coats were made using a 62% by weight PTFE dispersion containing glass microspheres and commercially available as Dyneon™ TFX 5041. A fourth coating was applied at 50 g/m² of PTFE using a dispersion containing 60% by weight of PTFE (commercially available as Dyneon™ TFX 5060).

This glass fiber cloth containing only PTFE coatings without IR absorbing particles has an emissivity of 0.88.

### Example 1

The coating procedure as carried out in the comparative example was repeated, but in place of the last coat of Dyneon™ TFX 5060 there was applied, a PTFE dispersion (diluted from commercially available PTFE dispersion Dyneon™ TFX 5060) having containing 10% by weight of aluminum paste relative to the weight of PTFE solids and having a total amount of solids of 62% by weight. The aluminum paste comprised 65% by weight of aluminum flakes, having an average size of 13 μm and a thickness of 0.2 μm, in water. The aluminum containing coating was applied such at an amount of 42.5 g/m² which contained about 5.9% of aluminum. The emissivity of the coated material was 0.60 and the light transmission was 0.1%.

### Example 2

The coating procedure as carried out in the comparative example was repeated to coat a total weight of coating material of 656 g/m², but in place of the last coat of Dyneon™ TFX 5060 there was applied, a PTFE dispersion (diluted from commercially available PTFE dispersion Dyneon™ TFX 5060) having containing 30% by weight of aluminum paste used in example 1 relative to the weight of solids and having a total amount of solids of 52% by weight. The aluminum containing coating was applied such at an amount of 22 g/m² which contained about 18.2% of aluminum. The emissivity of the coated material was 0.50 and the light transmission was 0.4%.

### Example 3

The material per Example 2 was annealed for 12 hours at 250° C. The transmission thereby increased to 1%. The emissivity was unchanged at 0.5.

### Example 4

The coating procedure as carried out in the comparative example was repeated to coat a total weight of coating material of 663 g/m², but in place of the last coat of Dyneon™ TFX 5060 there was applied, a PTFE dispersion (diluted from commercially available PTFE dispersion Dyneon™ TFX 5060) having containing 30% by weight of aluminum paste of Example 1 relative to the weight of solids and having a total amount of solids of 42% by weight. The aluminum containing coating was applied such at an amount of 30 g/m² which contained about 16.7% of aluminum. The emissivity of the coated material was 0.50 and the light transmission was 1%.

The caloric value of the low emittance material as measured according to DIN 51900 part 1 was 4041 J/g.

### Example 5

The material per Example 4 was annealed for 12 hours at 280° C. The transmission increased to 1.7%. The emissivity was unchanged at 0.5.

### Example 6

The procedure of Example 4 was repeated but instead of the aluminum containing PTFE dispersion, a fluoropolymer dispersion containing a mixture of PTFE and a PFA in equal amounts was used. This fluoropolymer dispersion further contained 50% by weight of the aluminum paste of Example 1 containing 65% by weight of aluminum in water. The total amount of solids in the dispersion was 65% by weight and 54 g/m² (dry weight) of this coating was applied on one side of the low emittance material as a last coating. The amount of aluminum in this coating was about 33% by weight. The emissivity was 0.45, the light transmission 0.7% and the caloric value according to DIN 51900 was 4015 J/g.

### Example 7

The procedure of Example 4 was repeated but instead of the aluminum containing PTFE dispersion, a fluoropolymer dispersion containing a mixture of PTFE and FEP in equal amounts was used. This fluoropolymer dispersion further contained 100% by weight of the aluminum paste containing 65% by weight of aluminum in water. The total amount of solids in the dispersion was 30% by weight and 12 g/m² (dry weight) of this coating was applied on one side of the low emittance material as a last coating. The amount of aluminum in this coating was about 40% by weight based on solids. The emissivity was 0.33 and the light transmission 0.7%.

### Example 8

A glass cloth in linen weave having a weight per unit area of 100 g/m² was coated with 44.9 g/m² of coating material in three coatings using Dyneon™ TFX 5060. As a last coat on one side there was applied 1.1 g/m² (dry weight) of a dispersion containing a total solids of 20% by weight and containing PTFE and FEP in equal amounts and the aluminum paste of Example 1 containing 65% by weight of aluminum in water. The amount of aluminum in the dispersion was about 40% by weight based on solids. The light transmission was 9% and the emissivity 0.45.

1. Use of a layer of fluoropolymer having dispersed therein infrared (IR) absorbing particles, as a low emissivity layer to reduce the amount of cooling or heating required to maintain a desired temperature for an interior space.

2. Use according to claim 1 wherein the IR-absorbing particles comprise metal particles.

3. Use according to claim 2 wherein said metal particles are aluminum particles.

4. Use according to any of claims 1 to 3 wherein said IR-absorbing particles have an average particle size of not more than 25 μm.

5. Use according to any of the previous claims wherein the IR-absorbing particles are in the formofflakes.

6. Use according to any of the previous claims wherein said layer of fluoropolymer and IR-absorbing particles is arranged in a low emittance material as an outermost layer on one or both sides of said low emittance material.

7. Low emittance article comprising a substrate having on at least one major surface thereof at least two layers, the outermost layer of which comprises a fluoropolymer and IR-absorbing particles in the form of flakes distributed in said outermost layer.

8. Low emittance article according to claim 7 wherein said IR-absorbing particles comprise metal particles.

9. Low emittance article according to claim 7 or 8 wherein said IR-absorbing particles have an average particle size of not more than 25 μm and a thickness of 0.01 μm to 1 μm.

10. Low emittance article according to any of claims 7 to 9 wherein said substrate comprises a glass fiber fabric.

11. Low emittance article comprising as an outermost layer on at least one side a layer comprising a fluoropolymer and IR-absorbing particles distributed in said layer, said low emittance article having an emissivity of not more than 0.6.

12. Coating composition for producing a low emissivity coating, said composition comprising a dispersion of a fluoropolymer and IR-absorbing particles in the form of flakes.

13. Coating composition according to claim 12 wherein said IR-absorbing particles comprise metal particles.

14. Roof, wall, tent or shading material comprising a low emissivity layer of a fluoropolymer and IR-absorbing particles dispersed in said layer.

15. Roof, wall, tent or shading material according to claim 14 comprising metal particles and having an emissivity of not more than 0.6.
